(19) United States
(12) Patent Application Publication
(10) Pub. No.: US 2006/0222326 A1
(43) Pub. Date: Oct. 5, 2006

(54) Recording apparatus

(75) Inventors: Hironori Komi, Tokyo (JP); Yusuke Yatabe, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/207,861

(22) Filed: Aug. 18, 2005

(30) Foreign Application Priority Data
Apr. 5, 2005 (JP) 2005-108146

(51) Int. Cl. H04N 5/91

(52) U.S. Cl. 386/83

(57) ABSTRACT

The invention provides an effective means that realizes a long-hour recording and multi-channel simultaneous recording of TV broadcast programs without sacrificing the picture quality in reproduction. The invention also enhances user-friendliness in recording multiple channels. The invention provides a transcoder for the digital broadcast, utilizes program information during recording, and adaptively controls the recording bit rate in correspondence with the maximum transfer rate of a record medium.

### BACKGROUND

The present invention relates to a recording apparatus.

The Japanese Unexamined Patent Publication No. 2003-32614 gives an example of the background art of the present invention. This publication describes the problem, “when detecting that the reproduction condition gives a low resolution, the signals are recorded to a record medium under a low resolution corresponding to the reproduction condition, to thereby enhance the efficiency of the recording capacity”. And, the publication describes the solution, “providing a recording module that records digitally transmitted contents to a specified record medium, when the condition to restrict the resolution in reproduction is set to recorded contents, this recording module records the contents under a low resolution set in reproduction”.

And, the Japanese Unexamined Patent Publication No. 2001-285801 gives another example of the background art of the present invention. This publication describes the problem “using a record medium efficiently as the problem in making a long-hour video recording”. And, the publication describes the solution, “When making a long-hour video recording using recording patterns having image quality information set to each of time zones, the picture quality corresponding to the current time is selected among the recording patterns set in a reservation setting memory when a reserved-recording start time comes, and the data transfer rate corresponding to the selected picture quality information is set to the encoder. On the basis of the selected picture quality information, the video recording is performed (S101-S104). And, the category codes indicating the program types are detected from reception signals received, and the video recording is made with a data transfer rate corresponding to a category code, thereby the data transfer rate corresponding to the program type is automatically selected, and the video recording by a desired data transfer rate is made”.

### SUMMARY

Digital recorders have been developed for general users, which apply digital coding to the analog TV broadcast signals by means of the MPEG technology on the receiver side and record the programs to a record medium such as a hard disk drive. Some of the digital recorders record multiple channel programs to a HDD for long hours. Besides, the digital TV broadcasting is launched, in addition to the conventional analog TV broadcasting. Some digital recorders appear on the market, which record the digital TV broadcast programs to a record medium. In this case, a broadcast station digitally codes broadcast contents and modulates coded signals and broadcasts from a satellite or a terrestrial broadcasting antenna. And, a receiver demodulates the reception wave of a selected broadcast and records coded streams to a record medium. In viewing the contents, a desired digital stream is read out from the record medium, decoded, and reproduced. Thus, a user is able to enjoy the contents.

In the future digital TV broadcast, it will be an important technical problem to realize a simultaneous recording of multi-channel programs and record the programs in a long-hour record medium while maintaining the picture quality.

The patent document 1 discloses a method that transforms the resolution according to the indicated resolution restriction in decoding, which is applied to a program, and saves the recording capacity.

As one of the problems here, the digital recorder that records the TV broadcast programs provides an effective module for a long-hour recording and multi-channel simultaneous recording without sacrificing the picture quality in reproduction as much as possible. As another problem, the digital recorder has to enhance user-friendliness in making multi-channel recordings. This applies not only to a case in which exists a visual restriction as in the patent document 1, but to a case in which a user adjusts the picture quality by the user's preference.

Accordingly, it is an object of the present invention to enhance user-friendliness of the digital recorder

The above object is achieved by the invention described in the claims of this application.

According to the present invention, the recording apparatus and the digital recorder will enhance the user-friendliness.

### BRIEF DESCRIPTION OF THE DRAWINGS

These and other features, objects and advantages of the present invention will become more apparent from the following descriptions when taken in conjunction with the accompanying drawings wherein:

FIG. 1 is a block diagram of a digital recorder of the embodiment 1;

FIG. 2 is a chart showing the correspondence of the aspect ratio and the recording bit rate in the embodiment 1;

FIG. 3 is a chart showing the recording bit rate setting by each type of the programs in the embodiment 3;

FIG. 4 is a block diagram of a digital recorder of the embodiment 4;

FIG. 5 is a chart explaining the program reservations in the embodiment 5; and

FIG. 6 is a block diagram of an AV transcoder.

### DETAILED DESCRIPTION OF THE PREFERRED EMBODIMENTS

The preferred embodiments will be described based on a transcoder. The description will be made mainly with a recording apparatus that extracts the data of desired channels from the signals being time-division multiplexed in conformity with the standard MPEG2Systems (ISO/IEC138181-1), and receives and records the data in conformity with the standards MPEG2AACAudio and MPEG2Video.

### Embodiment 1

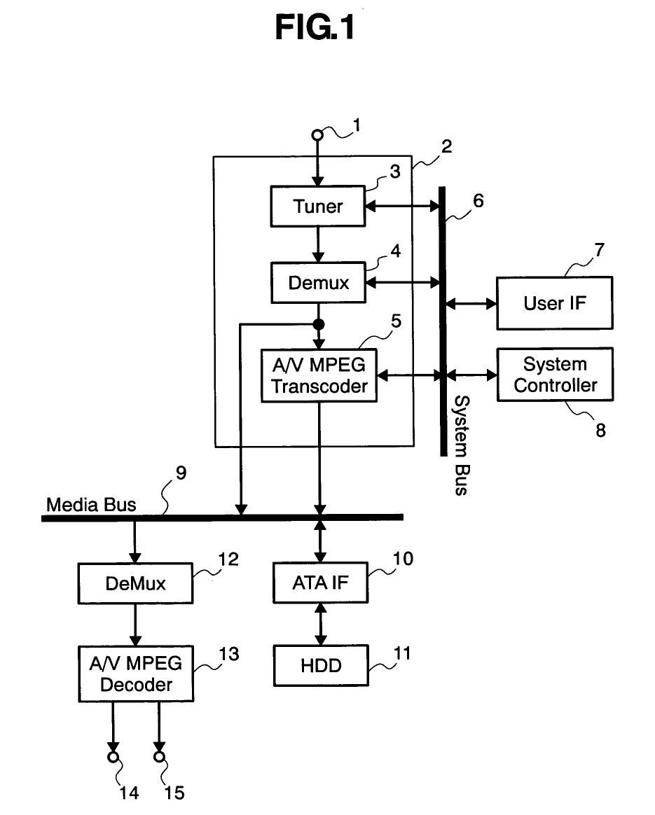

FIG. 1 is a block diagram of a digital recorder of the embodiment 1. In the drawing, the numerical symbol 1 signifies an antenna terminal, 2 a trans-code system, 3 a tuner, 4 a demultiplexer, 5 an AV transcoder, 6 a system bus, 7 a user-interface, 8 a system controller, 9 a media bus, 10 a media interface, 11 a hard disk drive, 12 a demultiplexer, 13 an AV decoder, 14 a video signal output terminal, and 15 an audio output terminal. Hereunder, the system operation will be described with FIG. 1. However, the details of the AV transcoder will be described later.

First, the operational process of recording the digital broadcast programs designated by a user to the hard disk drive will be described. The received digital broadcast signals are inputted to the antenna terminal 1. When the user designates a program to be recorded by way of the user-interface 7, the system controller 8 outputs a control signal by way of the system bus 6 so that the tuner 3 can tune and demodulate the desired channel. By this control, the signals demodulated by the tuner 3 are transformed into time-divided packets having a fixed-length packet called Transport Stream (TS) as a unit. The TS is controlled by the system controller 8 so that only the packets related to a specified program can be separately extracted by the demultiplexer 4. The TS contains the packets including the data (ES: Elementary Stream) in which the audio and video information on the desired program are coded and the packets of the encryption information related to the program and the program information and so forth. These packets are multiplexed and the demultiplexer 4 extracts the multiplexed packets necessary for the information. The extracted packets are recorded to the hard disk drive 11 by way of the media interface 10 for recording data in an HDD connected with the ATA-standard cable. Hereunder, the above recording method is called ‘direct recording’.

Next, the operational process that a user selects and reproduces the recorded data will be described. In reproduction, the user selects a desired program from the hard disk drive through the user-interface 7. The TS data related to the selected program are supplied to the demultiplexer 12 through the media interface 10. The demultiplexer 12 separates the video stream and the audio stream, and sends them to the AV decoder 13. The AV decoder 13 decodes the video stream and the audio stream individually, and outputs the decoded from the video signal output terminal 14 and the audio signal output terminal 15 separately.

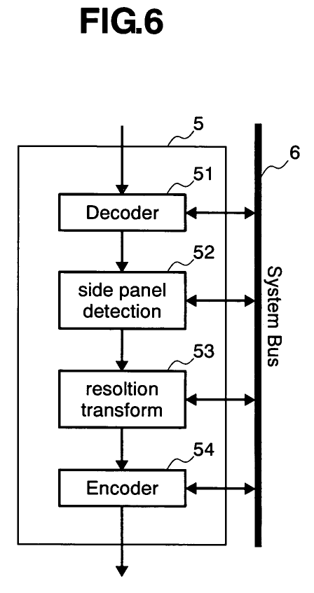

Next, described is the operational process of a program for trans-coding simultaneously with recording. The video stream and the audio stream separated by the demultiplexer 4 are inputted simultaneously to the AV transcoder 5, when being trans-coded. FIG. 6 illustrates an example of the AV transcoder 5. The AV transcoder 5 includes an AV decoder 51, a side panel detection circuit 52 (described in detail later), a resolution transform circuit 53, and an AV encoder 54, etc. The inputted streams are trans-coded into a video stream and an audio stream having different bit rates from those of the inputted streams. The trans-coding may be made such that the AV decoder 51 and the AV encoder 54 are connected in series, and the video and audio data once decoded are re-encoded with different bit rates as the target. In this case, it is also possible to reduce the quantity of information by the resolution transform circuit 53 down-converting the resolution after decoding. The streams rate-transformed by the AV transcoder 5 are recorded to the hard disk drive 11 in the same manner as the original streams are recorded. Hereunder, the recording accompanied with the trans-coding is called ‘transcoderecording’. The transcoder may transform the bit rate not only by means of one and the same compression system, but also by means of the other compression systems. For example, the transcoder may trans-code the bit streams of the MPEG2Video by using the H.264/AVC (1SO/1EC14496-10) being the super-compression technology.

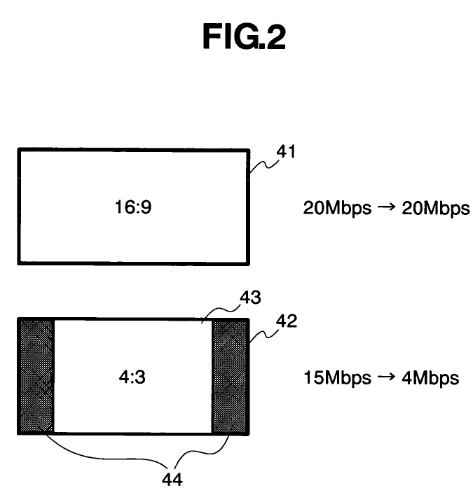

Next, the control of the direct recording and the transcoderecording will be described, which is the feature of this embodiment. FIG. 2 illustrates the control of the transcoderecording based on the aspect ratio. In the digital TV broadcasting, for example, the information on the attributes of the programs is transmitted as the program information. The information is extracted by the demultiplexer 4, which is transmitted to the system controller 8. The system controller 8 looks up the aspect ratio of the longitudinal length against the lateral length of the picture of each program written in the program information. In case of a program shot by digital broadcast apparatuses, the data having the wide aspect ratio of 16:9 is transmitted in general. In this case, when the original streams are decoded, the contents of the program can be viewed in a high picture quality. On the other hand, when the contents recorded for the conventional analog TV are broadcast through a digital broadcast system, since the original contents are shot by the broadcasting apparatus for the NTSC and so forth, most of the data have the standard picture size of 4:3, as illustrated by 42 in FIG. 2. In this case, even if the original bit rate is high, when the resolution of the original shooting apparatus is low, the picture quality of the decoded picture is not enhanced. Therefore, it can be considered that the transcoder reduces the bit rate and records the data; with this arrangement, a user is hard to feel the picture disagreeable, by reason that it lacks high-definition feeling remarkably.

Utilizing such characteristics, when the aspect ratio of a recoded program is that of the standard picture, the system controller 8 in this embodiment controls the bit rate in recording to be lower than that of the wide aspect ratio. In FIG. 2, for example, in regard to the streams of the aspect ratio 4:3, the bit rate of which have been 15 M bps on the input stage, the bit rate is transformed into about 4 M bps. And, in regard to the streams of the aspect ratio 16:9, the original bit rate is maintained and the direct recording is made (20 M bps in FIG. 2). While maintaining a positive evaluation on the picture quality to an originally high-definition picture that a user feels in viewing, this arrangement makes it possible to extend the total recording time of the hard disk drive 11.

Although the actual effective picture area corresponds to the area 43 in FIG. 2, the aspect ratio of which is 4:3, some broadcasting patterns fit the picture different from the animation of the contents (hereunder, mentioned as the side panel portion) in both the sides thereof, as the area 44 in FIG. 2, and output it with the wide aspect ratio of 16:9. In such a case, the side panel detection circuit 52 in FIG. 6 detects after decoding whether or not the still picture area is present on both the sides of the picture, and detects the side panel portion of the decoded picture. The system controller judges that the aspect ratio is 4:3 or 16:9 based on the presence or absence of the side panel portion. The digital recorder has a function to control the recording bit rate by the transcoder as mentioned above.

Further, in a case where the aspect ratios different from 4:3, 16:9 are used, when the high or low resolution is associated with the aspect ratio in general, when the aspect ratio used for the high resolution is detected, the application will be possible with enhancing the bit rate.

### Embodiment 2

Instead of controlling the recording bit rate in correspondence with the aspect ratio, as mentioned above, the trans-code may be controlled in correspondence with the input resolution information. The system configuration of the embodiment 2 is the same as FIG. 1. In the embodiment 2, when two contents having the vertical scanning lines 525 and 1125 are broadcast, the original resolution of the contents having the vertical scanning lines 525 is lower than that of the contents having the vertical scanning lines 1125. Therefore, if the contents having the vertical scanning lines 525 are broadcast with the same bit rate, the deterioration in the picture quality after the rate transform by the transcoderecording is slight compared to the case of the vertical scanning lines 1125. This results from that the original picture information is limited. Utilizing this characteristic, based on the resolution information of the programs extracted by the demultiplexer 4, the system controller 8 controls the trans-code in a manner that the recording bit rate of a program having a lower resolution becomes lower. Thus, it is possible to give priority to the picture quality of a program having an originally high definition, and to increase the total recording time of the hard disk drive 11. As another embodiment, the user-friendliness can be enhanced by allocating a larger bit rate to a larger number of the picture elements (frame resolution×frame rate) processed in one second.

### Embodiment 3

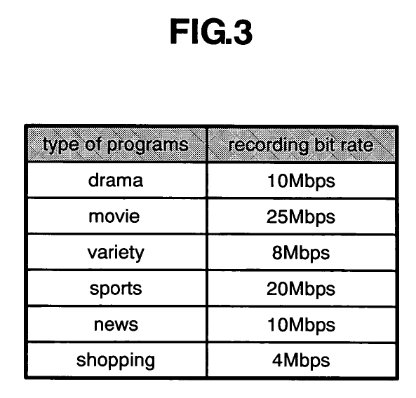

This embodiment 3 provides the system controller 8 with a module capable of presetting or setting through the user interface 7 the bit rates corresponding to the program types, as illustrated in FIG. 3. In the digital broadcast, the program types are broadcast as the program information contained in the TS. In this embodiment, the demultiplexer 4 extracts this information and the system controller 8 looks up the program types.

And, the trans-code system records by using the recording bit rates associated with the program types. If the recording bit rates in FIG. 3 are equal to or higher than the bit rates transmitted from a broadcast station, the system controller 8 controls the trans-code system 2 to make the direct recording with the broadcast bit rates. Thereby, if the setting of a bit rate is made to be equal to or higher than the maximum rate, and the trans-code is made to transform the bit rate to be equal to or higher than the maximum, the trans-coded bit rate becomes higher than the original bit rate. However, the picture quality cannot be enhanced higher than that of the decoded picture of the original stream. Therefore, the possible recording time of a storage medium is wasted uselessly, and providing the module to prevent the waste of the record medium will be effective in extending the total recording time of the medium.

If the set bit rate is lower than that of the transmitted bit rate, the system controller 8 controls the trans-code system 2 to make the recording with the target bit rate. Thereby, the recording bit rate suitable for each program type can adaptively be selected. The above method of selecting the bit rate controls the bit rate to follow a user's taste, performs a super-compression preferentially to a program that a user does not wish a high picture quality, and thereby extends the total recording time, while avoiding deterioration in the picture quality as to the program that the user prefers to reproduce in a high picture quality.

### Embodiment 4

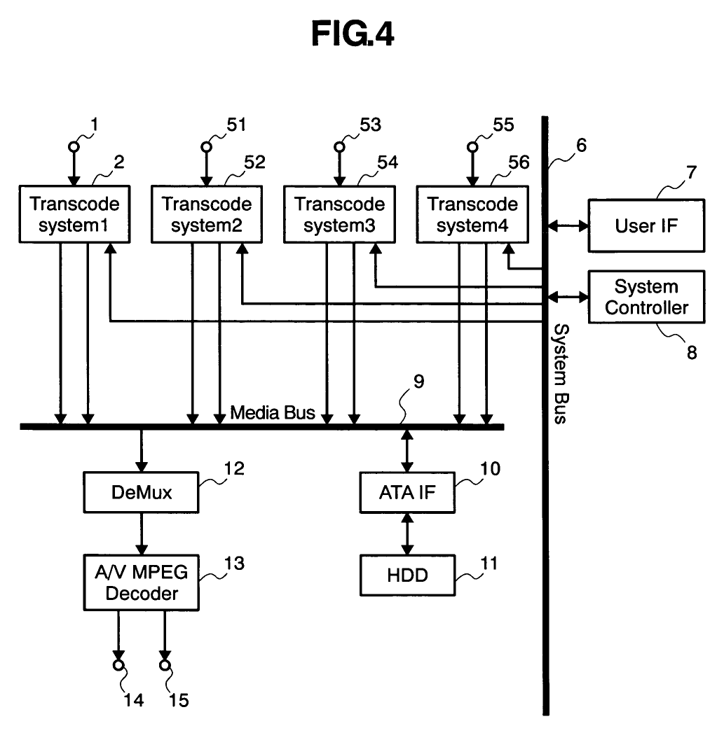

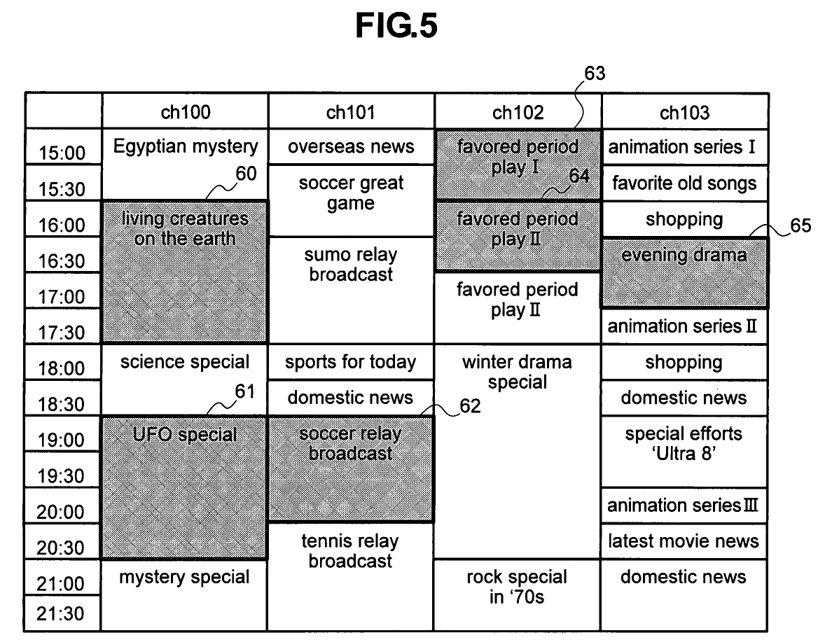

FIG. 4 illustrates a configuration of the embodiment 4. The same functional blocks as those in the Embodiment 1 are given the same numerical numbers. The digital recorder of this embodiment receives digital broadcast multi-channel programs simultaneously, controls the transcoderecording and the direct recording to the multi-channel programs individually independently, and records the programs to a storage medium. The trans-code systems 2, 52, 54, and 56 each demodulate and demultiplex the TS of different channel programs from the reception signals inputted through the antenna terminals 1, 51, 53, and 55. In the same manner as the embodiment 1, these trans-code systems are configured to perform the direct recording and the transcoderecording. The digital recorder in this embodiment is able to simultaneously record the programs of multiple channels (4 channels in this example) as illustrated in FIG. 5. The programs having the numerical numbers 60 through 65 given in FIG. 5 are those that a user explicitly assigns for the recording. Here, ‘explicitly’ means that the user selects a specified program, and that whether the user views it or not is unknown; however it excludes the recording as a panning shot. While the recording is not explicitly reserved, when the digital recorder of this embodiment performs recordings with low bit rates, this construction makes it possible to trans-code the multi-channel programs individually independently and lower the bit rates. When the start time of an explicit recording reservation comes, the circuit configuration for the low bite rate recording is changed into the path whereby only the concerned channel is directly recorded; thereby, only one channel can be recorded with a high bit rate. This construction makes it possible to transform the recording bit rates of all the channel programs adaptively and seamlessly, without interrupting the recording during the trans-coding of the other channel programs.

This construction includes an interface that discriminates a program to which an explicit recording reservation is performed through the user interface 7 by a user's instruction from an implicit recording program recorded and stored to the record medium for the time being. When a user makes an explicit recording reservation, the user interface 7 provides an input module, whereby the user can designate the recording bit rate of the concerned program. The module may be a remote controller or a GUI (Graphic User Interface) system, for example. The system controller 8 stores in advance the management table of the program information extracted from the TS, and stores the program that the user made the recording reservation in the form of a flag in the management table. The flag may be stored in the hard disk drive 11 or another record medium. Here, the programs 60 through 65 are those that have already been reserved explicitly.

Under the circumstances where the programs are reserved, the system controller 8 looks up the management table corresponding to the current day and time. If the flag for the recording reservation is set to the program corresponding to the time, the system controller 8 controls the trans-code system of the corresponding channel to record the program with the reserved bit rate set in advance. On the other hand, as to the program without the recording reservation, the system controller 8 controls the trans-code system of the corresponding channel to perform the recording with the recording bit rate for an implicit recording different from the reservation bit rate. In this case, the recording bit rate for an implicit recording is set lower than the recording bit rate for a reserved program. With regard to the program that a user made the recording reservation, that is, the program that the user views afterwards with a high probability, the system controller 8 assigns a high bit rate to maintain the picture quality.

With regard to the program that the user did not designate the reservation, that is, the program that the user views afterwards with a low probability, the system controller 8 assigns a low bit rate. This method will make it possible to extend the total recording time of the storage medium, compared to performing the direct recording to all the transmitted data, while maintaining the picture quality as to the program that the user views with a high probability. This method also provides the user with a function whereby the user prevents a reservation failure, or a function whereby the user looks up the programs to view afterwards, by recording the programs other than the reserved programs, thus enhancing user-friendliness.

As another embodiment, the following digital recorder can be considered which records digital broadcast programs. The recorder includes a recording module that records digital broadcast programs, an erasing module that erases programs recorded by the recording module, and a control module that controls to erase the recorded programs on the basis of attribute information of the programs recorded by the recording module. The digital recorder may record the programs that the control module controls to erase, with lower bit rates than those of the programs that the control module does not control to erase. A user has a tendency to implicitly record the programs other than those that the user explicitly instructs to record. To prepare for such a case, a system can be considered which retains the recorded contents for a certain period from the time of recording and erases the recorded after the period elapses. In this case, the digital recorder records the programs of which retention of the recorded is not so important, with lower bit rates than those in the recording of the other programs. Thus, the digital recorder is able to use the record medium efficiently.

In this embodiment, the digital recorder records the multi-channel programs simultaneously to the hard disk drive; accordingly, the total data rate for recording to the hard disk drive will increase compared to the case of one channel recording. In this condition, if the total data rate to the hard disk drive exceeds the effective transfer rate (Sustained Transfer Rate/Sequential Transfer Rate: average transfer rate in consideration for the seek time of the head and the overhead of intermittent writings) of the hard disk drive, the system controller 8 will control the trans-code systems to maintain the recording bit rates of the programs having explicitly recording reservations made and reduce the recording bit rates of the other programs. When the recording is made on the day and time of the program list in FIG. 5, for example, during 16:00-16:30, the reserved recordings are performed to ch100, ch102, and ch103 and the implicit recording is performed to ch101. The effective transfer rate of the hard disk drive is assumed 100 M bps, and the recording bit rates of ch100, ch102, and ch103 are assumed each 30 Mbps. In this case, the system controller 8 controls the corresponding trans-code system 2 (52 in FIG. 4) to reduce the bit rate of ch101 preferentially and make it lower than 10 M bps. And even though the recording bit rate of the not-explicitly-reserved program is lowered, if the total data rate exceeds the effective transfer rate of the hard disk drive, the system controller 8 stops the recording of ch101 in which the implicit recording is made. Further, if the total of the recording bit rates of the explicitly-reserved programs alone exceeds the permissible maximum transfer rate, the system controller 8 controls the trans-code systems corresponding to ch100, ch102, and ch103 to lower the recording bit rates each, and thereby prevents the explicitly-reserved recordings from a failure.

In the embodiment 3 of the present invention, the recording bit rates are set each to the program types, based on the program information of the digital TV broadcasts. However, a system that receives the analog TV broadcasts and encodes the program data to record them to the record medium is able to attain the program information by way of the Internet, for example, and to recognize each of the program types. With this arrangement, the digital recorder in the embodiment 3 is able to adaptively control the recording bit rates corresponding to the program types each, and to realize efficient long-hour recordings, in the same manner as in the embodiment 4. In the above embodiments, the trans-code systems are assumed to take on hardware configurations; however, a system is conceivable which trans-codes the programs through software processing and controls this processing. When receiving the Internet broadcasts by a personal computer, for example, the same effects can be attained.

In the above embodiments, the digital recorder adaptively changes the recording system in correspondence with the possibility of a user reproducing the recorded programs afterwards and the picture quality of the original program sources; thereby, the embodiments effect to extend a substantial recording time of the storage medium, while satisfying the demand for maintaining the picture quality. And, a user is able to extend the recording time of the storage medium efficiently, without complicated designations of compression rates; in consequence, the user friendliness is enhanced. Further, it is possible to increase the number of channels that can be recorded simultaneously.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

What is claimed is:

1. A recording apparatus that records video and audio signals, comprising:
an aspect ratio detection module that detects aspect ratios of inputted video and audio signals, and
a control module that controls recording of the video and audio signals by a bit rate corresponding to a detection by the aspect ratio detection module.

2. A recording apparatus according to claim 1, wherein the aspect ratio detection module detects the aspect ratios on the basis of a still picture area of the inputted video signals

3. A recording apparatus that records video and audio signals, comprising:
a resolution detection module that detects resolutions of inputted video and audio signals, and
a control module that controls recording of the video and audio signals by a bit rate corresponding to a detection by the resolution detection module.

4. A digital recorder that records digital broadcast programs, comprising:
a detection module that detects bit rates of the digital broadcast programs,
a user setting module that a user sets recording bit rates in recording the digital broadcast programs,
wherein a bit rate detected by the detection module and a bit rate set by the user setting module are compared, and when the bit rate detected by the detection module is lower, the program is recorded with a digital broadcast bit rate.

5. A digital recorder that records digital broadcast programs, comprising:
a detection module that detects bit rates of the digital broadcast programs,
a program type recognition module that recognizes program types of the programs,
a bit rate setting module that sets recording bit rates to each of the program types corresponding to recognitions by the program type recognition module,
wherein a bit rate detected by the detection module and a bit rate set by the bit rate setting module are compared, and when the bit rate detected by the detection module is lower, the program is recorded with a digital broadcast bit rate.

6. A digital recorder that records digital broadcast programs, comprising:
a user setting module that a user sets recording bit rates in recording the digital broadcast programs, wherein:
the programs of which recording the user designates explicitly are recorded with recording bit rates set by the user setting module, and
the programs of which recording the user does not designate explicitly are recorded with lower bit rates than the recording bit rates set by the user setting module.

7. A digital recorder that records digital broadcast programs, comprising:
plural trans-code modules having a first output part that outputs with bit rates of the digital broadcast programs, and a second output part that outputs with lower bit rates than the bit rates of the digital broadcast programs.

8. A digital recorder according to claim 7, wherein
the bit rates with which the plural trans-code modules record are controlled within an sustained transfer rate of a record medium that the digital recorder possesses.

9. A digital recorder according to claim 7, wherein
the programs of which recording the user designates explicitly and the programs of which recording the user does not designate explicitly are compared, recording bit rates are determined while giving priority to the programs of which recording the user designates explicitly.

10. A digital recorder built-in television that incorporates the recording apparatus according to claim 1.

11. A recording apparatus comprising:
a reception part that receives modulated data,
a demodulation part that demodulates data received by the reception part,
a demultiplexing part that extracts desired data from data demodulated by the demodulation part,
a control part that performs a control corresponding to attribute information of data extracted by the demultiplexing part,
a coding part that trans-codes the data on the basis of the control of the control part, and
a recording part that records data trans-coded by the coding part.

12. A recording apparatus according to claim 11,
wherein the attribute information of the data are information on aspect ratios.

13. A recording apparatus according to claim 11,
wherein the attribute information of the data are information on resolutions.

14. A digital recorder that records digital broadcast programs, comprising:
a recording module that records the digital broadcast programs,
an erasing module that erases programs recorded by the recording module, and
a control module that controls to erase the recorded programs on the basis of attribute information of the programs recorded by the recording module.
wherein the programs that the control module controls to erase are recorded with lower bit rates than those of the programs that the control module does not control to erase.

15. A recording apparatus that records video signals, comprising:
an aspect ratio detection module that detects aspect ratios of inputted video signals, and
a control module that controls recording of the video signals by a bit rate corresponding to a detection by the aspect ratio detection module.

16. A recording apparatus according to claim 15,
wherein the control module controls the bit rate corresponding to a case in which the aspect ratio of the video signals detected by the aspect ratio detection module is 4:3, to be lower than the bit rate corresponding to a case in which the aspect ratio of the video signals is 16:9.

17. A recording apparatus that records video signals, comprising:
a resolution detection module that detects resolutions of inputted video signals, and
a control module that controls recording of the video signals by a bit rate corresponding to a detection by the resolution detection module.

18. A recording apparatus according to claim 17,
wherein the control module controls the bit rate corresponding to
a case in which the number of pixels processed in a given time of the video signals detected by the resolution detection module is small, to be lower than the bit rate corresponding to a case in which the vertical resolution of the video signals is large.
